(19) United States
(12) Patent Application Publication
(10) Pub. No.: US 2023/0339266 A1
(43) Pub. Date: Oct. 26, 2023

(54) Agricultural Vehicle Tire with Lightweight Crown

(71) Applicant: COMPAGNIE GENERALE DES ETABLISSEMENTS MICHELIN, Clermont-Ferrand (FR)

(72) Inventors: Philippe JOHNSON, Clermont-Ferrand Cedex 9 (FR); Nizar DIDANE, Clermont-Ferrand Cedex 9 (FR)

(21) Appl. No.: 18/024,674

(22) PCT Filed: Sep. 2, 2021
(86) PCT No.: PCT/FR2021/051508

§ 371 Date: Mar. 3, 2023

(30) Foreign Application Priority Data
Sep. 4, 2020 (FR) FR2008993

(51) Int. Cl. B60C 9/00

(52) U.S. Cl. CPC B60C 9/0042; B60C 2200/08; B60C 2009/2016

(57) ABSTRACT

A radial tire (1) for an agricultural vehicle, which tire has a speed index at least equal to D for a maximum speed equal to 65 km/h, has a load index at least equal to 140 and at most equal to 170, and has a tread pattern comprising lugs with a radial height at least equal to 45 mm, having a crown reinforcement (3), consisting of 3 crown layers (31, 32, 33), each having reinforcing elements made of PET having an ultimate tensile strength at least equal to 32 daN, and the angles ANT1 and ANT3 of the reinforcing elements of the radially inner and outer layers (31, 33) with the circumferential direction have the same orientation and are less than 20°, and the angle ANT2 of the reinforcing elements of the median layer (32) with the circumferential direction has an opposite orientation to ANT1 and is greater than 10° plus the absolute value of the average of ANT1 and ANT3.

A subject of the present invention is a radial tire for an agricultural vehicle referred to as a low-power or medium-power tractor, and more particularly relates to its crown reinforcement.

The dimensional specifications and the use conditions (load, speed, pressure) of a tire for low-power and medium-power tractors are defined by the use. The tires have average to large sizes depending on the crop type. The diameter of the mounting rims of these tires is at least equal to 28 inches. For agricultural tires, the minimum recommended inflation pressure corresponding to the indicated loading capacity is usually at most equal to 300 kPa, but may drop as low as 240 kPa for an “IF”, or “Improved Flexion”, tire, or even 160 kPa for a “VF”, or “Very high Flexion”, tire. IF tires are distinguished from standard tires referred to as NF (Normal Flexion), specifically those that are not part of the IF or VF classification according to the 2020 ETRTO (“European Tire and Rim Technical Organization”) standard, of the same size in terms of load-bearing capacity that is increased by 20% at constant pressure, or a pressure that is 20% lower with the same load, and this figure is 40% in each case for VF tires. The invention has an interest in Normal Flexion tires. The maximum speed of these tires is 65 km/h, which corresponds to the speed index D. The load index of these tires is at least equal to 140 (2500 kg) and at most equal to 170 (6000 kg).

A tire for an agricultural vehicle comprises a tread intended to come into contact with the ground via a tread surface, the two axial ends of which are connected via two sidewalls to two beads that provide the mechanical connection between the tire and the rim on which it is intended to be mounted.

In the following text, the circumferential, axial and radial directions refer to a direction tangential to the tread surface and oriented in the direction of rotation of the tire, to a direction parallel to the axis of rotation of the tire, and to a direction perpendicular to the axis of rotation of the tire, respectively.

A radial tire for an agricultural vehicle comprises a reinforcement consisting of a crown reinforcement radially on the inside of the tread and of a carcass reinforcement radially on the inside of the crown reinforcement WO2019/073143.

The tread of a tire for an agricultural vehicle generally comprises a plurality of raised elements, known as tread pattern elements or blocks, which extend radially outward from a bearing surface, or bottom of the tread pattern, as far as the tread surface and are usually separated from one another by voids or grooves. These tread pattern elements are usually lugs generally having an elongate shape that is parallelepipedal overall and comprises at least one rectilinear or curvilinear portion. The size of the lugs, specifically their radial height and their circumferential thickness, is essential to ensure a sufficient traction force on loose ground.

The carcass reinforcement of a radial tire for an agricultural vehicle comprises at least one carcass layer connecting the two beads to one another. A carcass layer comprises reinforcers, or reinforcing elements, that are coated in a polymer material comprising an elastomer, obtained by blending, or elastomer compound. The carcass layer reinforcers usually consist of textile polymer materials, such as a polyester, for example. The reinforcers of a carcass layer are substantially mutually parallel and form an angle of between 85° and 95° with the circumferential direction.

The crown reinforcement of a radial tire for an agricultural vehicle comprises a superposition of circumferentially extending crown layers, radially on the outside of the carcass reinforcement. Each crown layer consists of reinforcers that are coated in an elastomer compound and are mutually parallel. When the reinforcers of a crown layer form an angle at most equal to 10° with the circumferential direction, they are referred to as circumferential, or substantially circumferential, and perform a hooping function that limits the radial deformations of the tire. When the reinforcers of a crown layer form an angle at least equal to 10° and usually at most equal to 40° with the circumferential direction, they are referred to as angled reinforcers, and have a function of reacting the transverse loads, parallel to the axial direction, that are applied to the tire. The crown layer reinforcers may consist of textile polymer materials, such as a polyester, for example, or of metal materials, such as steel.

A tire for an agricultural vehicle is intended to run over various types of ground such as the more or less compact soil of the fields, unmade tracks providing access to the fields, and the tarmacked surfaces of roads. Bearing in mind the diversity of use, in the fields and on the road, a tire for an agricultural vehicle needs to offer a performance compromise between traction in the fields on loose ground, resistance to chunking, resistance to wear on the road, resistance to forward travel, vibrational comfort on the road, resistance to fatigue caused by the number of revolutions, and the weight, this list not being exhaustive.

One of the avenues of essential research in a world with limited resources is to reduce the weight of the products used to manufacture the tire.

The inventors have set themselves the objective of maintaining the endurance of a crown reinforcement of an agricultural tire, to a level at least equivalent to that of a crown reinforcement with at least 4 working layers of textile reinforcing elements whilst still reducing the number of working layers so as to decrease the weight of the tire.

This aim has been achieved by a radial tire for an agricultural-type vehicle, which radial tire is NF (“Normal Flexion”), which, according to the 2020 ETRTO (“European Tire and Rim Technical Organization”) standard, has a speed index at least equal to D for a maximum speed equal to 65 km/h, which tire is intended to be mounted on a rim with a diameter at least equal to 28 inches, and has a load index at least equal to 140 and at most equal to 170, comprising:
a tread intended to come into contact with the ground, which tread has an axial width LT and comprises a central portion with an axial width LT/2 and two axially outer portions, each with an axial width LT/4,
the two axially outer portions comprising tread pattern blocks with a radial height at least equal to 45 mm, these blocks covering at least 80% of the axial width LT/4 of the axially outer portions of the tread and having a circumferential thickness ep at least equal to 42 mm,
a crown reinforcement radially on the inside of the tread, comprising 3 working layers: a radially innermost working layer, a radially outermost working layer and an intermediate working layer, each working layer comprising mutually parallel textile reinforcing elements made of PET (polyethylene terephthalate), which are coated in a rubber material and form angles at least equal to 12° and at most equal to 45° with the circumferential direction of the tire,
the reinforcing elements of the working layers having an ultimate tensile strength at least equal to 32 daN,
the angles (ANT1, ANT3) respectively formed by the reinforcing elements of the radially innermost working layer and the radially outermost working layer with the circumferential direction being at most equal to 20° and having the same orientation,
the angle ANT2 formed by the reinforcing elements of the intermediate working layer with the circumferential direction having an opposite sign to the angles ANT1 and ANT3,
the absolute value of the angle ANT2 being greater than 10° plus the absolute value of the average of the angles ANT1 and ANTS.

The solution works particularly well for agricultural tires having blocks or lugs, which are long tread pattern blocks having an axial width close to half the axial width of the tread. Designing a more compact structure with grooves and blocks with a small radial height, notably, would certainly make it possible to find a more lightweight solution by virtue of better exchange of heat between the crown layers and the outside of the tire and by decreasing the flexion of the crown in line with the lugs. Such a tread pattern would make it possible to decrease the mechanical and thermal stresses caused by the use of metal cords, for example, but would be adversely affected in terms of grip on loose ground.

The tread pattern blocks of the axially outer portions of the tread of the tires to which the invention relates have an axial width at least equal to 80% of the axial width of the axially outer portions of the tread, specifically LT/4, LT being the axial width of the tread. What this is understood to mean is that the axial distance from the axially outer end of the tread pattern block to its axially inner end is at least equal to 80% of one quarter the axial width of the tread. The axial width will be measured when the tire is new and to avoid the details of the sidewalls, and the points at which the measurements are taken will be part of the block and on its tread surface.

For effective operation on loose ground and notably when towing tools such as a plough, the tread pattern height or radial height of the lugs or tread pattern block is at least equal to 45 mm.

For sufficient resistance of the tread pattern elements to chunking and good transmission of the motor torque on loose ground, the circumferential thickness of the tread pattern blocks or of the lugs, measured halfway between the bottom of the tread pattern and the tread surface and in the circumferential plane passing through the centre of the axially outer portions of the tread, is at least equal to 42 mm. Furthermore, a preferred solution for limiting the thermal stresses whilst still keeping resistance of the tread pattern elements to chunking for use by medium-power tractors is that the circumferential thickness of the tread pattern is at most equal to 80 mm. This geometric feature of the tread pattern blocks or of the lugs is the most pertinent one as regards cracking under the thermal stresses of the compounds close to the axial ends of the crown layers. This circumferential distance is the distance over which the tread pattern block or the lug influences the operation of the crown layers, by deformation of the crown layers that it entails when running on a ground which does not deform much and by thermal insulation as regards the outside air that it generates as long as, for agricultural use, the tread pattern height is particularly great.

In these conditions, in order for a crown reinforcement comprising less than 4 crown layers to have an endurance equivalent to the crown reinforcements with 4 crown layers that are sold on the market, it is essential that the reinforcing elements of the said crown layers have a force at break at least equal to 32 daN, measured according to the standard denoted D885/D885M-10A (2014) and that they are composed of at least two PET strands with a behaviour under compression that will protect the crown from breaking.

In a configuration with 3 crown layers, it is crucial to balance the angles of the reinforcing elements of the three layers in a very particular way. Usually, on a crown with 4 crown layers, the crown layers are balanced in pairs, a radially inner pair and a radially outer pair. In each pair of crown layers, the reinforcing elements of the two layers are crossed relative to one another in relation to the median circumferential plane, the absolute values of the angles formed with the circumferential direction having the same value to within plus or minus 3°. For certain pairs, the absolute values of the said angles are between 15° and 30° to react mainly the circumferential forces, and other ones greater than 30° have the objective of reacting forces in the transverse direction.

Certain tires for passenger vehicles or heavy duty vehicles have configurations with 3 crown layers, notably a configuration with two adjacent crown layers, the respective reinforcing elements of which form opposite angles having similar absolute values with the circumferential direction, said crown layers being combined with a crown layer referred to as hooping layer, the reinforcing elements of which form an angle at most equal to 10° with the circumferential direction. This configuration is completely unsuitable for the agricultural tires targeted by the invention. Working at the low pressure accepted for agricultural vehicles, for tread patterns with very great heights, at least equal to 30 mm, generates excessive cycles of tensile loading and compressive loading for hooping layers, such that this solution is effective.

Another configuration with 3 crown layers that is known in essentially heavy-duty tires, but with metal reinforcing elements, combines two adjacent working layers, the respective reinforcing elements of which form opposite angles having similar absolute values with the circumferential direction, said working layers being combined with a radially innermost crown layer referred to as triangulation layer, the reinforcing elements of which form an angle with an absolute value at least equal to 50° with the circumferential direction. However, this solution is not suitable for the tires to which the invention relates, since this ply operates under excessive compression for the textile reinforcing elements more suited to agricultural use, a metal version with 3 crown layers only making the tire even heavier, this being contrary to the aim of the invention.

A solution with 3 textile crown layers would have worse performance in terms of durability for IF (Improved Flexion) use or VF (Very high Flexion) use in relation to the current solutions.

It would therefore be necessary to find an arrangement of crown layers, angles and materials that make it possible to solve the technical problem specific to this context. The solution such that the angles ANT1, ANT3 respectively formed by the reinforcing elements of the radially innermost working layer and of the radially outermost working layer with the circumferential direction are at most equal to 20° and have the same orientation, and such that the angle ANT2 formed by the reinforcing elements of the median working layer with the circumferential direction has the opposite sign to the angles ANT1 and ANT3, and such that the absolute value of the angle ANT2 is greater than 10° plus the absolute value of the average of the angles ANT1 and ANT3, enables a very good balance between tensile and compressive stresses in all of the reinforcing elements of all the crown layers. None of the crown layers is subjected to excessive tensile stress like with a hooping layer or excessive compressive stress like with a triangulation layer. Positioning the central layer so that it is crossed with the two others enables a double coupling conducive to the endurance of the crown. The angles that the reinforcing elements of the crown layers make with the circumferential direction are measured in the median circumferential plane.

A preferred solution is that the reinforcing elements of the working layers consist of two PET strands, since this material and this architecture make it possible to obtain reinforcing elements which are not very sensitive to compression and have a small enough diameter to increase the thickness of the crown layers and therefore the weight, a strand being an assembly of elementary fibres.

For good resistance to the compressive forces, it is preferred that each PET strand of the reinforcing elements of the working layers has a linear density at least equal to 320 g per km.

The preferred solution is a tire in which the reinforcing elements of the 3 working layers are cords that consist of two PET strands with a linear density of between 320 and 360 g per km and are laid at a pitch of between 1.2 mm and 1.5 mm. The pitch at which the strands are laid is the distance measured between the two centres of two adjacent reinforcing elements of a working layer perpendicularly to these two reinforcing elements.

One advantageous solution is that the absolute value of the angles ANT1, ANT3 is between 13° and 17° and the absolute value of the angle ANT2 is between 27° and 33°, preferably the absolute value of the angles ANT1 and ANT3 is between 14.5° and 15.5° and the absolute value of the angle ANT2 is between 29.5° and 30.5°. This configuration demonstrated a particularly advantageous balance between the various forces acting on the reinforcing elements of the crown layers.

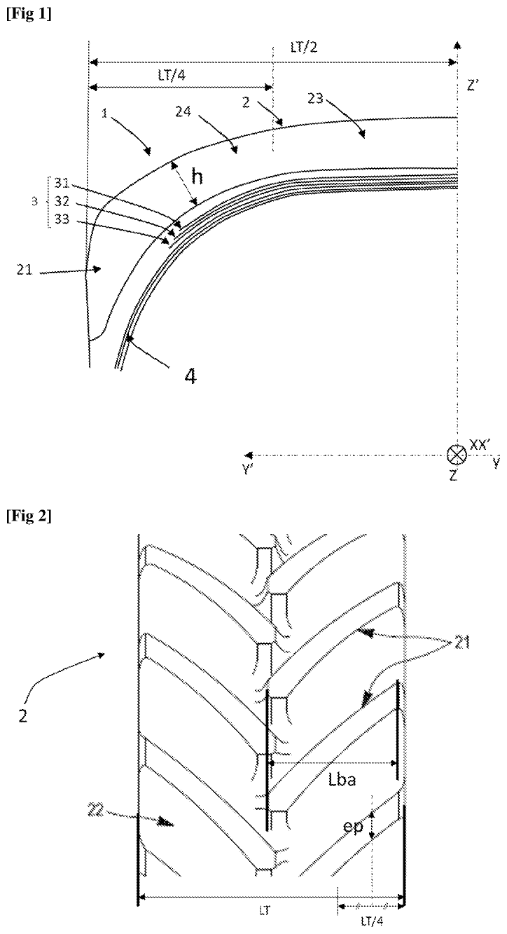

The features of the invention are illustrated by the schematic FIGS. 1 and 2, which are not drawn to scale:

FIG. 1: shows a diagram of a meridian half-section through the tire according to the invention,

FIG. 2: shows a segment of the tread pattern of the tire according to the invention.

FIG. 1 [FIG. 1] shows a segment of the crown of the tire according to the invention in a meridian plane YZ passing through the axis of rotation YY of the tire. The tire 1 for an agricultural vehicle for a medium-power tractor comprises a crown reinforcement 3 radially on the inside of a tread 2 and radially on the outside of a carcass reinforcement 4. The crown reinforcement 3 comprises 3 crown layers (31, 32, 33), each comprising mutually parallel textile reinforcing elements which are composed of two PET strands coated in an elastomeric material and form an angle A (not shown) at least equal to 15° and at most equal to 45° with a circumferential direction (XX′). The carcass reinforcement 4 comprises one or more carcass layers comprising mutually parallel textile reinforcing elements that are coated in an elastomeric material and form an angle (not shown) at least equal to 85° and at most equal to 95° with the circumferential direction (XX′). The tread 2 comprises tread pattern blocks 21, in this instance continuous blocks usually referred to as lugs with a radial height h at least equal to 45 mm. The tread has an axial width LT and comprises a central portion 23 having an axial width LT/2 and two axially outer portions 24, each having an axial width LT/4. The lugs or tread pattern blocks have an axial width Lba greater than 0.8*LT/4.

FIG. 2 [FIG. 2] shows a segment of the tread 2 of a tire for an agricultural vehicle. The tread 2 has an axial width LT and comprises tread pattern blocks 21, in the present case lugs, and voids 22 that enable good grip on loose ground. The tread pattern blocks 21 on the axially outer portions of the tire have an axial width Lba greater than 80% of LT/4. When the tire is running, since the thickness of the lugs increases the thermal stresses, this type of tread generates cycles of compressive/tensile loading in the reinforcers of the crown layers, for which it is necessary to balance the angles particularly well so as to be able to reduce the weight of the crown reinforcement to only 3 crown layers. To resist chunking, the lugs have a circumferential thickness ep, measured halfway up the tread pattern in the circumferential plane passing through the centre of each axially outer portion of the tread, at least equal to 42 mm. This thickness also has an impact on the thermal stresses in this area.

The invention was implemented more particularly for an agricultural tire of size 650/65R38 NF, specifically one that is not classified as IF or VF according to the 2020 ETRTO standard. The tire according to the prior art comprises 4 crown layers with reinforcing elements consisting of two PET strands having a linear density of 220 g per km, the reinforcing elements being disposed at a pitch of 1.15 mm. The angles formed by the reinforcing elements of the working layers in the median circumferential plane with the circumferential direction, from the radially innermost layer to the radially outermost layer, are −25°, 25°, −25°, 25°. The tread pattern is composed of lugs with a radial height of 60 mm, a circumferential thickness ep measured in the middle of each axially outer portion that is equal to 74 mm, and an axial width representing 51% of the total width of the tread.

The tire according to the invention is identical to the control except that it comprises 3 crown layers, the reinforcing elements of which are cords consisting of two PET strands with a linear density equal to 344 g per km, the reinforcing elements of the working layers being disposed in the working layers at a pitch equal to 1.35 mm. The PET strand has a force at break equal to 20 daN, and the reinforcing elements have a force at break equal to 35 daN. The angles formed by the reinforcing elements of the working layers in the median circumferential plane with the circumferential direction, from the radially innermost to the radially outermost, are equal to −15°, 30°, −15°.

The tire according to the invention makes it possible to decrease the weight of the crown layers by 5.2 kg, that is to say 27%, and has been tested in terms of endurance. The inventors tested the invention by comparing the service life, as regards the endurance of the crown reinforcement, of the two tires for medium-power tractors. Each tire was run on a steel rolling road with a diameter of 1.7 m at a speed V equal to 15 km/h, each tire being inflated to a pressure P equal to 260 kPa, specifically the nominal pressure increased by 1 bar, and subjected to load levels equal to 4047 daN for 24 h, then 4856 daN for 24 h, then 6475 daN for 24 hours, and lastly 8094 daN for 328 hours. The tire according to the invention, with a lower weight, travelled an equivalent number of kilometres as the tire according to the prior art, without exhibiting any failure of the reinforcing elements of the working layers, demonstrating the advantage of the invention in realizing a more lightweight tire with equivalent endurance.

1. A radial tire for a vehicle of the agricultural and NF (“Normal Flexion”) type, which, within the meaning of the 2020 ETRTO (“European Tire and Rim Technical Organization”) standard, has a speed index at least equal to D for a maximum speed equal to 65 km/h, which tire is intended to be mounted on a rim with a diameter at least equal to 28 inches, and has a load index at least equal to 140 and at most equal to 170, comprising:
a tread intended to come into contact with the ground, which tread has an axial width LT and comprises a central portion with an axial width LT/2 and two axially outer portions, each with an axial width LT/4,
the two axially outer portions comprising tread pattern blocks with a radial height at least equal to 45 mm, these blocks covering at least 80% of the axial width LT/4 of the axially outer portions of the tread and having a circumferential thickness ep at least equal to 42 mm,
a crown reinforcement radially on the inside of the tread, comprising 3 working layers a radially innermost working layer a radially outermost working layer and an intermediate working layer, each working layer comprising mutually parallel textile reinforcing elements made of PET (polyethylene terephthalate), which are coated in a rubber material and form angles at least equal to 12° and at most equal to 45° with the circumferential direction of the tire,
the reinforcing elements of the working layers having an ultimate tensile strength at least equal to 32 daN,
wherein the angles (ANT1, ANT3) respectively formed by the reinforcing elements of the radially innermost working layer and the radially outermost working layer with the circumferential direction are at most equal to 20° and have the same orientation,
wherein the angle ANT2 formed by the reinforcing elements of the intermediate working layer with the circumferential direction has an opposite sign to the angles ANT1 and ANT3,
wherein the absolute value of the angle ANT2 is greater than 10° plus the absolute value of the average of the angles ANT1 and ANT3.

2. The tire according to claim 1, wherein the reinforcing elements of the working layers consist of two PET strands, one strand being an assembly of elementary fibres.

3. The tire according to claim 2, wherein each PET strand of the reinforcing elements of the working layers has a linear density at least equal to 320 g per km.

4. The tire according to claim 3, wherein the reinforcing elements of the working layers are cords which consist of two PET strands with a linear density of between 320 and 360 g per km and are spaced apart at a pitch of between 1.2 mm and 1.5 mm.

5. The tire according to claim 4, wherein the absolute value of the angles ANT1 and ANT3 is between 13° and 17° and the absolute value of the angle ANT2 is between 27° and 33°.

6. The tire according to claim 5, wherein the absolute value of the angles ANT1 and ANT3 is between 14.5° and 15.5° and the absolute value of the angle ANT2 is between 29.5° and 30.5°.
